(19) United States
(12) Patent Application Publication
(10) Pub. No.: US 2007/0228199 A1
(43) Pub. Date: Oct. 4, 2007

(54) MOBILE CONSTRUCTION DEBRIS SHREDDER SYSTEM

(76) Inventors: John Ulitsch, Smyrna, GA (US); Wendall R. Kitchens, Smyrna, GA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/278,454

(22) Filed: Apr. 3, 2006

(51) Int. Cl. B02C 19/00

(52) U.S. Cl. 241/101.741

(57) ABSTRACT

A mobile construction debris shredder having a debris shredder enclosure for receiving construction debris to be shredded, a feed conveyor operatively connected to the debris shredder enclosure for transporting the construction debris to be shredded to the debris shredder enclosure, debris shredding equipment contained within the debris shredder enclosure for shredding the construction debris into shredded debris, a hopper for receiving and storing the shredded debris; and a shredded debris conveyor for conveying the shredded debris from the debris shredder enclosure to the hopper. A method for disposing of construction debris by shredding the construction debris into shredded debris using the mobile construction debris shredder and dispersing the shredded debris at a construction site as mulch.

### BACKGROUND OF THE INVENTION

1. Technical Field

The present invention generally is related to devices and systems for removing, disposing of, shredding or crushing, and the remediation of debris, and more specifically is related to mobile, truck-mounted devices, systems and methods for the on-site shredding and relocation of construction debris. The invention also generally is related to mobile devices and systems, and methods for implementing mobile systems and devices, for on-site shredding of construction debris for reuse as mulch.

2. Prior Art

Construction debris, for the most part, currently is removed from the construction site and disposed of elsewhere. The disposal of construction debris, such as wood panels and studs and drywall, while possibly not being a particularly large line-item cost in the overall construction budget, has the potential of having high future costs. For example, the construction debris must be disposed of somewhere, and on-site burial and off-site landfill fast are becoming unavailable, unlawful, less desirable and/or more costly. On-site burial not only is unlawful in many jurisdictions, but has the potential of lowering land values due to the presence of an on-site waste area and of resulting sink holes created as the debris settles and decomposes. Similarly, it is unlawful in many jurisdictions to burn construction debris. Landfills are becoming less desirable and typically are not considered good neighbors. It is estimated that up to 50% of the total volume being placed in urban landfills is construction debris, and such urban landfills are fast becoming filled to capacity.

Many categories of construction debris are recyclable and can be more valuable if recycled rather than disposed of. Additionally, various state and federal governmental agencies may offer incentives for recycling debris. For example, drywall, which is the principal wall material used in the United States for interior purposes, is made of a sheet of gypsum covered on both sides with a paper facing and a paperboard backing. It is estimated that over ten percent of all drywall used in new construction is wasted during installation. Waste drywall can be recycled as a soil amendment, as the clinker in cement plants, in water treatment, as animal bedding, and as the lime to mark athletic fields. For another example, wood boards and studs can be ground up into mulch that can be used as a ground cover.

Grinding or shredding construction debris also can reduce the volume of debris that needs to be removed from a construction site and therefore can simplify the debris removal. For example, various categories of debris can be ground on-site using commercially available grinding devices. Concrete can be ground and placed in a first pile, wood can be ground and placed in a second pile, and so forth. Each pile is relatively uniform and can be disposed of as desired or reused on site for soil amendment or mulch or, in the case of concrete, road bedding. Using such grinders, the particle size of the debris can be reduced from feet to inches and the volume of the debris reduced up to 50% or more. This also can help reduce tipping fees, which are the charges paid to landfills, if the tipping fees are based on truckload and not on weight.

There are many other benefits to the reduction and reuse of construction debris. However, there are few devices and systems that provide a comprehensive solution to the problem of dealing with construction debris. Accordingly, there is a need for a device and system that provides for the remediation of construction debris in a more economical manner. There also is a need for a device and system that provides for the remediation of construction debris that allows for the reuse of the construction debris on the construction site. There is a further need for a device and system that provides for the remediation of construction debris that allows for the simple transport of shredded construction debris to other construction sites for reuse or to disposal sites for disposal. There also is a need for methods for implementing such devices and systems. It is to these needs and others that the present invention is directed.

### BRIEF SUMMARY OF THE INVENTION

Briefly, the present invention is a mobile construction debris shredder mounted on a truck bed and the use thereof. Generally speaking, the invention is a system and device, and a method for implementing the system and device, comprising a mobile shredder for on-site shredding of construction debris for reuse as mulch, the device allowing one to load debris onto the shredder, the shredding of the debris, and the distributing of the shredded debris as mulch onto the site preferably without disturbing the environmental controls, such as silt fences. For simplicity, the construction debris shredder often will be referred to simply as the shredder and the construction debris or waste often will be referred to simply as debris throughout this specification. Generally, the shredder is designed and configured to be mounted on a truck that can be driven both on the construction site and on the public roads. Further, the shredder is designed such that debris can be loaded onto the shredder without having to remove or damage silt fences, curbstones, small walls and the like.

The mobile shredder comprises, in addition to the truck cab, frame, engine and other operating features of a generally conventional truck, a feed conveyor, a debris shredder, a shredded debris conveyor, a storage hopper for storing the shredded debris, and a dumping or dispersing system, all of which are installed on a truck bed. Many optional additional features are contemplated, including without limitation a metals removal system such as a magnet, an interior dispersing system for more evenly dispersing the shredded debris within the hopper, and a conveyor for moving the shredded debris within the hopper to the dumping or dispersing system.

The feed conveyor is used to elevate and dump the debris into an opening in the top or top side of the debris shredder, or shredding equipment, enclosure. Preferably, the conveyor is of the endless belt type and is movable from a storage position proximal to the truck to an operating position extending from the truck proximal to the debris to be shredded. In its operating position, the conveyor is attached to or proximal to the opening in the debris shredder enclosure and extends down to the debris or to a level at which workers can load debris onto the conveyor. Preferably, the loading conveyor extends over the silt fence from the road to the pile of debris on the site. Debris is loaded onto the conveyor and the endless belt transports the debris up to the opening. The conveyor can have ridges or other protuberances or indentions to help prevent the debris from sliding downwards while being conveyed. The opening can have a safety door to help prevent debris or non-debris, such as the workers, from entering or falling into the debris shredder enclosure.

The debris shredder, or shredding equipment, can be any type of shredding equipment currently known or future developed that is capable of shredding the types of debris contemplated, such as, for example purposes only, wood, wallboard, cardboard boxes, crating materials, plastics, medium density fiberboard, and cementious boards. A preferred debris shredder comprises a rotating toothed drum. The debris is dumped onto a feed plate within the debris shredder enclosure. A ram pushes the debris to the rotating toothed drum and when the debris contacts the rotating teeth of the toothed drum, the rotating teeth shred the debris to a desired size. The teeth can be removed and replaced when worn. Additionally, the preferred teeth have a generally square cross section with four cutting surfaces such that the teeth can be rotated when one side becomes dull. Further, the teeth placement on the drum can be configured to direct the shredded debris to a specific location within the debris shredder enclosure for ease of manipulating the shredded debris on to the next component of the invention. Additional teeth can be added, which allows for the throughput of a greater volume of debris. The shredding equipment is contained within the debris shredder enclosure, which typically preferably minimally comprises a floor and surrounding walls.

The shredded debris, when properly reduced in size, passes through a screen comprising multiple openings or sieve gaps. The screen is located below the rotating toothed drum and acts as a regulator for the particle size of the shredded debris. The screen preferably is removable and replaceable, and the holes through the screen, or mesh size, can be selected as desired for different final sizes of the shredded debris. Shredded debris of the desired size will pass through the screen, while shredded debris larger than the desired size will remain on top of the screen to be further acted upon by the rotating toothed drum for further shredding.

The shredded debris conveyor comprises two components or sections. The first component is a generally horizontal conveyor that conveys the shredded debris to the second component, which is a generally sloped conveyor that conveys the shredded debris from the debris shredder enclosure to the hopper. The first component can be any type of conveyor equipment currently known or future developed that is capable of conveying the shredded debris horizontally or generally horizontally including, but not limited to, endless belts systems and augers. The preferred first component is a screw auger that conveys the shredded debris passing through the screen to the second component, or to an access device leading to the second component, typically located at the rear of the debris shredder enclosure. The second component also can be any type of conveyor equipment currently known or future developed that is capable of conveying the shredded debris upwards or generally upwards including, but not limited to, endless belts systems and augers. The preferred second component also is a screw auger that conveys the shredded debris upwards from the bottom of the debris shredder enclosure to the top of the hopper.

The first and second components can be combined as the first and second sections of a single shredded debris conveyor system. This would be best illustrated by a belt, cup or bucket conveyor that transitions from horizontal to angled transport. Alternatively, if space allows, a single angled for raising conveyance component can be used in place of the first and second components or sections.

A metal products removal device can be located between the shredded debris conveyor and the hopper. A representative metal products removal device comprises a rare earth ceramic magnet and a roller that sifts out any ferrous metal, such as nails, and deposits them into a collector device so that the mulched product resulting from the shredded debris can be placed on the ground without being contaminated by metal products. Other devices such as vibrating sieves also can be used, the sieves having relatively small openings through which nails, but not shredded debris, can fall. Other devices such as vibrating sieves also can be used, the sieves having relatively small openings through which nails, but not shredded debris, can fall.

The hopper is for storing the shredded debris and preferably is a separate component or enclosure located proximal to, and preferably behind the debris shredder enclosure relative to the front of the truck. This configuration allows for greater ease and flexibility in dumping or dispersing the shredded debris if, for example, the hopper has a tipping feature. The hopper generally is an enclosure adapted for receiving and storing the shredded debris and minimally comprises a floor and surrounding walls. The second component of the shredded debris conveyor dumps the shredded debris into an opening at the top of the hopper. The hopper can further comprise a device or devices more evenly distributing the shredded debris within the hopper. Optionally, the hopper or other components of the invention can comprise other means for removing other undesirable materials from the shredded debris prior to redistributing the shredded debris as mulch or other ground cover. Further, the hopper can comprise a live floor both for more evenly distributing the shredded debris within the hopper and for dumping or dispersing the shredded debris from the hopper.

Shredded debris exits the hopper through a port preferably located at the bottom of the hopper, which location helps to use gravity as an assist in removing the shredded debris from the hopper. The port can range from a simple opening to a more complex spreading device. Minimally, the port should allow the shredded debris to be dumped or dispersed from the hopper. Exit ports also can be located on any of the sides of the hopper if so desired. The shredded debris is removed from the hopper via a dumping or removal device, preferably another auger, that extends back over the silt fence so as to be able to dump the shredded debris as mulch onto a selected position on the site.

Structurally, the shredder comprises a truck having a cab, an engine and a frame or bed. The frame supports the debris shredder enclosure and the hopper, as well as being an actual or ultimate support for the rotating toothed drum, the screen, the shredded debris conveyor and the various other components of the device and system. The various powered components of the invention, such as the rotating toothed drum and the various conveyance devices, preferably are hydraulically operated, with power for the hydraulics preferably coming from the truck engine. Alternatively, a separate engine or engines specifically for powering the hydraulics or other operating systems, such as optional electric motors, of the invention can be included and employed. Although electric and other types of engines can be used, a hydraulic system is preferred as the load effect on a hydraulic system is less pronounced than it is on an electric engine. The debris shredder enclosure preferably is located immediately behind the cab, and the hopper preferably is located immediately behind the debris shredder enclosure, with the shredded debris conveyor located generally between the debris shredder enclosure and the hopper.

The feed conveyor preferably loads the debris into the debris shredder enclosure from the side of the truck. As such, it has been found to be more efficient to have the rotating toothed drum mounted horizontally such that the axis of rotation is horizontal relative to the truck frame and extends front to back relative to the truck frame. Similarly, as the hopper is located behind the debris shredder enclosure, the first component of the shredded debris conveyor, namely the screw auger, preferably is mounted horizontally below the screen such that the axis of rotation is horizontal relative to the truck frame and extends front to back relative to the truck frame. The second component of the shredded debris conveyor, namely the screw auger, preferably is mounted between the debris shredder enclosure and the hopper at an angle or vertically so as to allow the conveyance of the shredded debris from the bottom of the debris shredder enclosure to the top of the hopper. As such, the axis of rotation of the second component is angled upward and rearward, or vertical, relative to the truck frame. The devices for more evenly distributing the shredded debris within the hopper and the live floor within the hopper each can be mounted front to back or side to side within the hopper, as desired. Both of these devices typically are rollers or augers.

The orientation of the various components of the invention has been designed to improve performance. As configured, the feed conveyor delivers debris directly to the debris shredder without an extended conveyance path. The debris is fed directly into the debris shredder enclosure and is forced by the ram against the rotating toothed drum. The debris promptly is shredded when forced against the teeth or when contacted by the teeth when sifting on the screen. The close spatial relationship between the feed conveyor and the rotating toothed drum helps to ensure that the shredded debris remains within the invention. Likewise, the direct conveyance of the shredded debris by the first component along the bottom of the debris shredder conveyor to the second component of the shredded debris conveyor, and by the second component to the hopper also ensures that the shredded debris remains within the invention. Further, by having a generally closed system, the present invention helps to reduce the creation and dispersal of dust, which can be a problem with many prior art debris removal systems.

Although the invention can be used on many different types of construction sites, in a best mode it is for use in residential construction due to the types of debris created during residential construction. For example, wood makes a more favored mulch, and residential construction produces relatively more wood debris than, for example, commercial construction, which produces relatively more metal and cementious debris. Additionally, the relatively lower quantity of debris produced during residential construction complements the practicality of the invention when used on residential construction sites. Further, this invention can be used in new and remodeling construction applications. This invention also has the ability to offer curbside service, as it can be driven right up to the house or construction site to shred the debris.

Further, as part of the method, the invention can be driven to specific construction sites, including small sites, where construction debris can be picked up, shredded, and either returned as mulch to the site or transported to another site for use as mulch. This can be helpful to builders, who can make separate piles of different types of debris at or near the curb and use the invention to remove the debris. As a bonus, larger pieces of debris, such as larger pieces of studs or drywall, can be left as is for use by the builder for mounting pipes, for trimming and blocking, and for other secondary uses.

These features, and other features and advantages of the present invention will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

FIG. 1 is a perspective view of a preferred embodiment of the mobile construction debris shredder of the present invention.

FIG. 2 is a sectional side view of the preferred embodiment of the mobile construction debris shredder shown in FIG. 1.

FIG. 3 is a front view of the feed conveyor of the present invention.

FIG. 4 is a side view of the feed conveyor of FIG. 3, shown lowered to feed debris from ground level.

FIG. 5 is a sectional rear view of the debris shredder of the present invention along line 5′-5′ of FIG. 2.

FIG. 6 is a sectional rear view of the feed conveyor and debris shredder as shown in FIGS. 4 and 5 showing the transport of debris from the construction site, up the feed conveyor, into the debris shredder enclosure, to the rotating toothed drum, through the screen and to the first component of the shredded debris conveyor.

FIG. 7 is a side view of the rotating toothed drum of the present invention.

FIG. 8 is a sectional rear view of the hopper of the present invention shown along line 8′-8′ of FIG. 2.

FIG. 9 is a sectional side view of the hopper as shown in FIG. 8 and the shredded debris conveyor showing with reference arrows the transport of the shredded debris through the shredded debris conveyor into the hopper.

FIG. 10 is a rear view of the hopper of the present invention showing the dumping or dispersion of shredded debris.

### DETAILED DESCRIPTION OF THE PREFERRED EMBODIMENTS

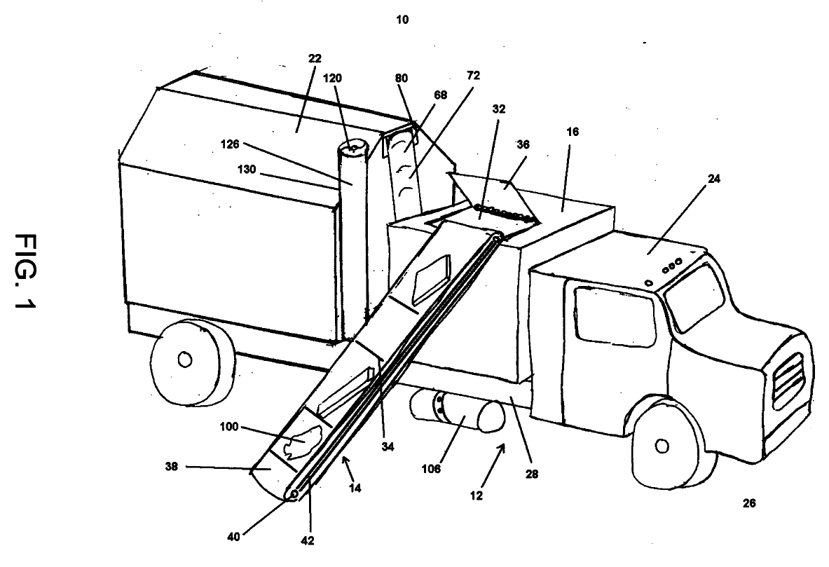

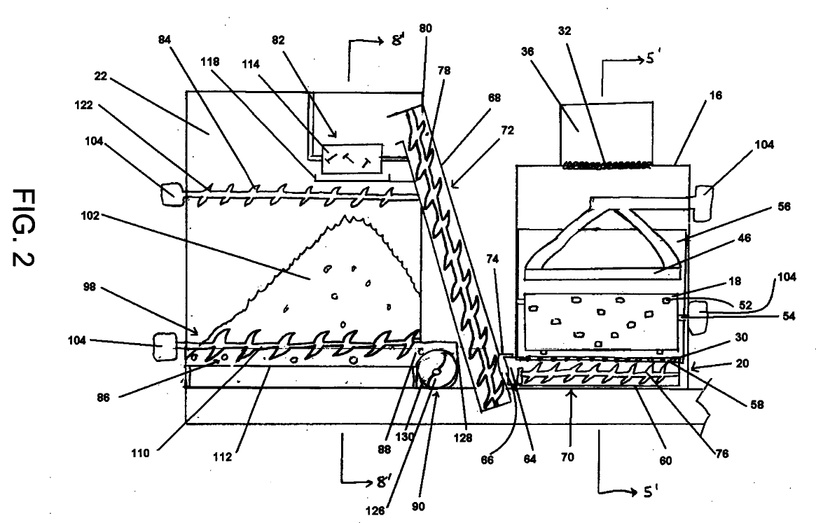

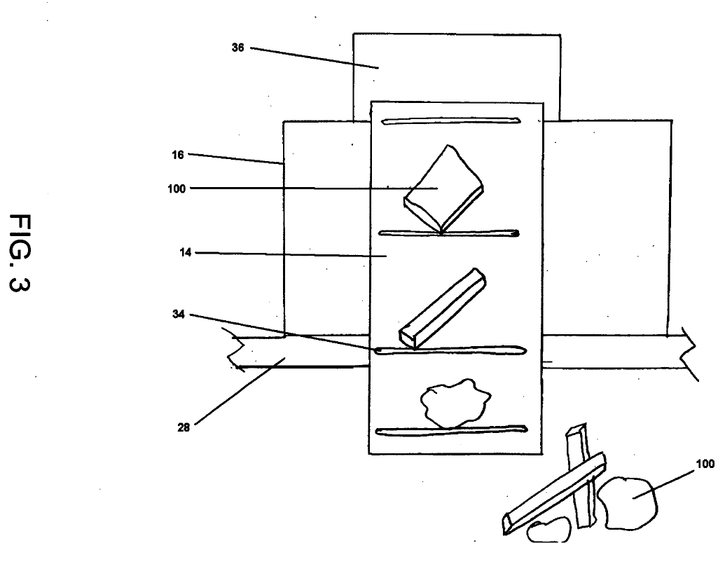

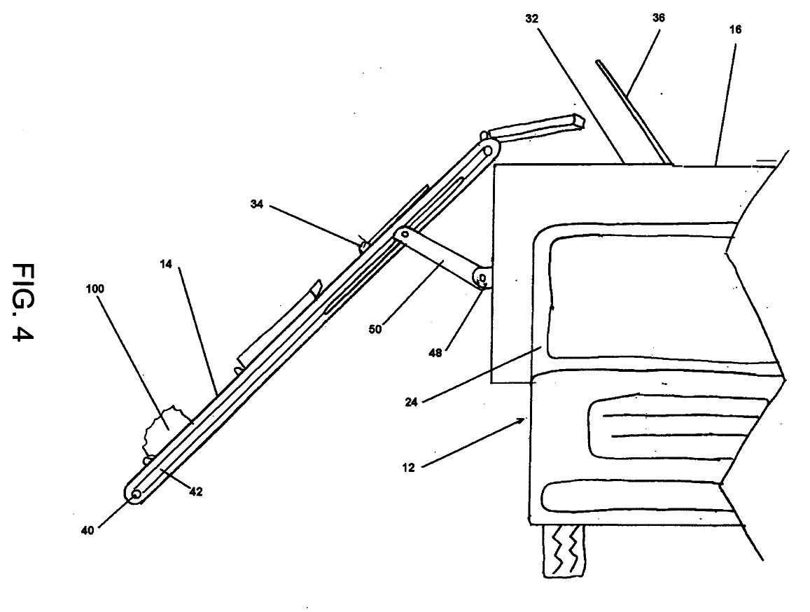

FIG. 1 is a perspective view of a preferred embodiment of the mobile construction debris shredder of the present invention showing the structural relationship of the major components to each other. FIG. 2 is a sectional side view of the preferred embodiment of the mobile construction debris shredder shown in FIG. 1. FIG. 3 is a front view of the feed conveyor of the present invention. FIG. 4 is a side view of the feed conveyor of FIG. 3, shown lowered to feed debris from ground level up to the ingress to the debris shredder enclosure.

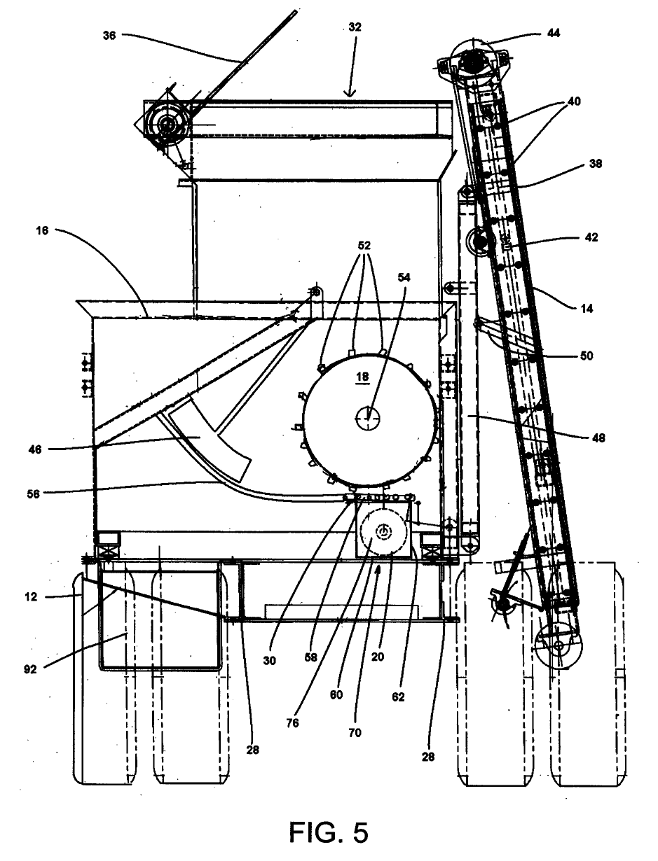

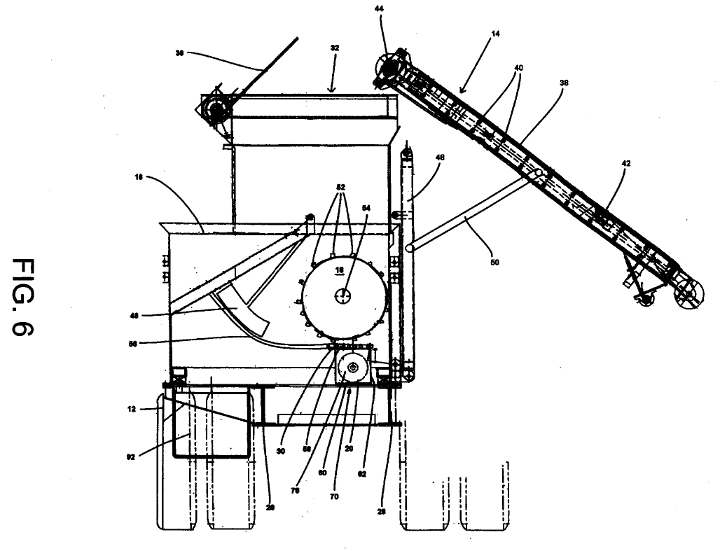

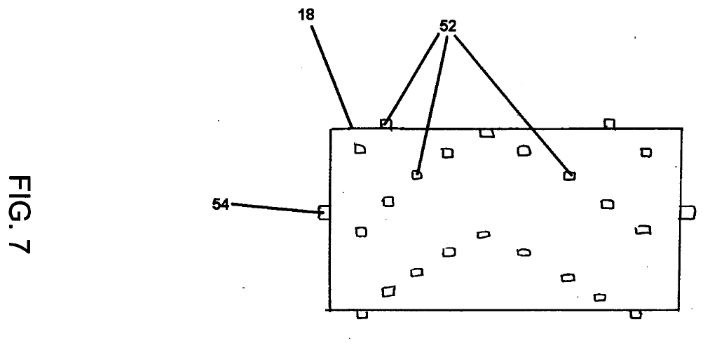

FIG. 5 is a sectional rear view of the debris shredder of the present invention along line 5′-5′ of FIG. 2 showing the internal workings of the invention. FIG. 6 is a sectional rear view of the feed conveyor and debris shredder as shown in FIGS. 4 and 5 showing the transport of debris from the construction site, up the feed conveyor, into the debris shredder enclosure, to the rotating toothed drum, through the screen and to the first component of the shredded debris conveyor. FIG. 7 is a side view of the rotating toothed drum of the present invention showing how the rotating toothed drum acts upon the debris.

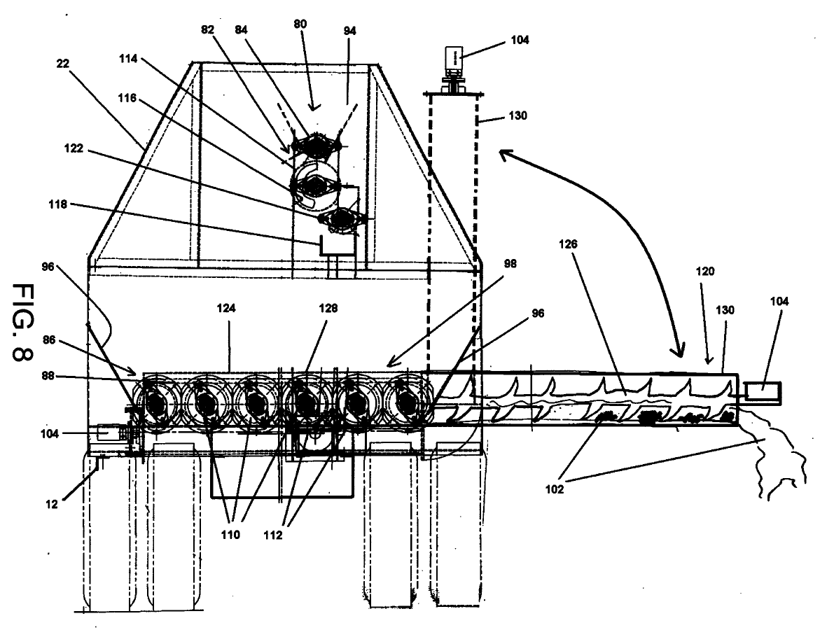

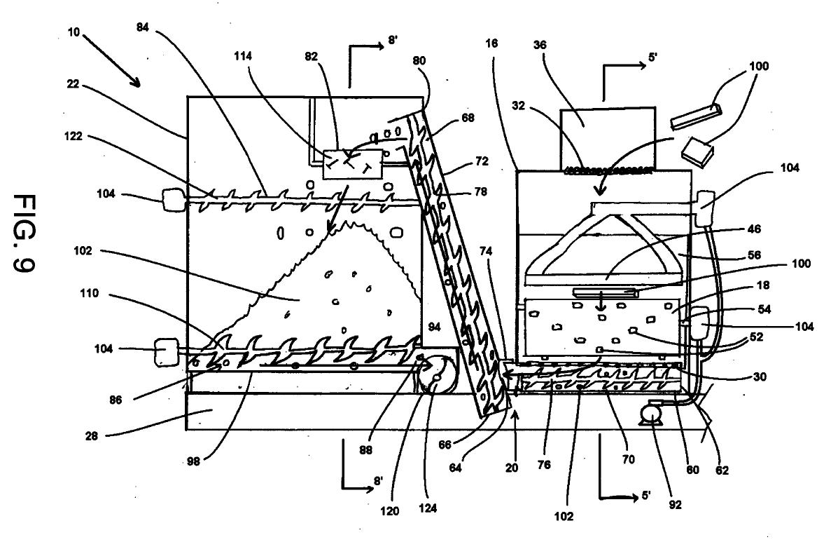

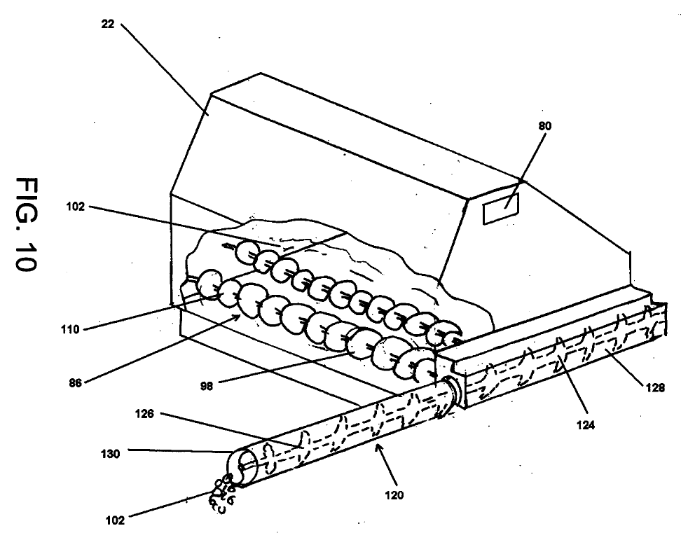

FIG. 8 is a sectional rear view of the hopper of the present invention shown along line 8′-8′ of FIG. 2 showing the internal structure and workings of the hopper. FIG. 9 is a sectional side view of the hopper as shown in FIG. 8 and the shredded debris conveyor showing the transport of the shredded debris through the shredded debris conveyor into the hopper. FIG. 10 is a rear view of the hopper of the present invention showing the dumping or dispersion of shredded debris.

In a general embodiment, the invention is a mobile construction debris shredder system, comprising:
(a) A debris shredder enclosure for receiving construction debris to be shredded;
(b) a feed conveyor operatively connected to the debris shredder enclosure for transporting the construction debris to be shredded to the debris shredder enclosure;
(c) debris shredding equipment contained within the debris shredder enclosure for shredding the construction debris into shredded debris;
(d) a hopper for receiving and storing the shredded debris; and
(e) a shredded debris conveyor for conveying the shredded debris from the debris shredder enclosure to the hopper.

In another embodiment, the invention is a mobile construction debris shredder system, comprising:
(a) A debris shredder enclosure for receiving construction debris to be shredded;
(b) a feed conveyor operatively connected to the debris shredder enclosure for transporting the construction debris to be shredded to the debris shredder enclosure;
(c) debris shredding equipment contained within the debris shredder enclosure for shredding the construction debris into shredded debris, wherein the debris shredding equipment comprises a rotating toothed drum having a plurality of shredding teeth; a screen for screening the shredded debris, the screen having sieve gaps of a selected size through which the shredded debris can pass to the shredded debris conveyor; and a feed plate and a ram for feeding the construction debris to be shredded to the debris shredding equipment, wherein the construction debris to be shredded at least partly falls onto the feed plate and the ram forces the construction debris to be shredded to the debris shredding equipment;
(d) a hopper for receiving and storing the shredded debris;
(e) a shredded debris conveyor for conveying the shredded debris from the debris shredder enclosure to the hopper;
(f) a spreading device operatively connected to the hopper for receiving the shredded debris from the hopper and for depositing the shredded debris onto a location for depositing the shredded debris; and
(g) a truck on which the mobile construction debris shredder is mounted.

In a particular embodiment, the invention is a mobile construction debris shredder system, comprising:
(a) A debris shredder enclosure for receiving construction debris to be shredded;
(b) a feed conveyor operatively connected to the debris shredder enclosure for transporting the construction debris to be shredded to the debris shredder enclosure;
(c) debris shredding equipment contained within the debris shredder enclosure for shredding the construction debris into shredded debris, wherein the debris shredding equipment comprises a rotating toothed drum having a plurality of removable shredding teeth mounted on the toothed drum in a V-formation with the apex of the formation in a trailing position; a removable screen for screening the shredded debris, the screen having sieve gaps of a selected size through which the shredded debris can pass to the shredded debris conveyor, wherein if the shredded debris is larger than a selected particle size, then the shredded debris will remain on the screen for further shredding, and if the shredded debris is smaller than the selected particle size, then the shredded debris will pass through the sieve gaps to the shredded debris conveyor, the selected particle size corresponding to the selected size of the sieve gaps; and a feed plate and a ram for feeding the construction debris to be shredded to the debris shredding equipment, wherein the construction debris to be shredded at least partly falls onto the feed plate and the ram forces the construction debris to be shredded to the debris shredding equipment;
(d) a hopper for receiving and storing the shredded debris, wherein the hopper comprises a removal device, located proximal to the bottom of the hopper, for removing the shredded debris from the hopper;
(e) a shredded debris conveyor for conveying the shredded debris from the debris shredder enclosure to the hopper;
(f) a spreading device operatively connected to the hopper for receiving the shredded debris from the hopper and for depositing the shredded debris onto a location for depositing the shredded debris; and
(g) a self-propelled truck on which the mobile construction debris shredder is mounted.

The invention also can be used as an improvement to the current mobile shredding art. In one such improvement embodiment, the invention is used in combination with a truck mounted mobile construction debris shredder having a debris shredder enclosure for receiving construction debris to be shredded, a feed conveyor operatively connected to the debris shredder enclosure for transporting the construction debris to be shredded to the debris shredder enclosure, debris shredding equipment contained within the debris shredder enclosure for shredding the construction debris into shredded debris, and a hopper for receiving and storing the shredded debris, the improvement comprising a shredded debris dispersal means for dispersing the shredded debris at a construction site as mulch.

In another improvement embodiment, the invention is used in combination with a truck mounted mobile construction debris shredder having a debris shredder enclosure for receiving construction debris to be shredded, a feed conveyor operatively connected to the debris shredder enclosure for transporting the construction debris to be shredded to the debris shredder enclosure, debris shredding equipment contained within the debris shredder enclosure for shredding the construction debris into shredded debris, and a hopper for receiving and storing the shredded debris, the improvements comprising the debris shredding equipment having a rotating toothed drum shredder having a plurality of removable teeth; a screen for screening the shredded debris, the screen having sieve gaps of a selected size through which the shredded debris can pass to the hopper such that if the shredded debris is larger than a selected particle size, then the shredded debris will remain on the screen for further shredding, and if the shredded debris is smaller than the selected particle size, then the shredded debris will pass through the sieve gaps to the hopper, the selected particle size corresponding to the selected size of the sieve gaps; and a shredded debris dispersal means for dispersing the shredded debris at a construction site as mulch.

The invention further comprises a method for disposing of construction debris comprising the general steps of (a) shredding the construction debris into shredded debris using debris shredding equipment mounted on a mobile construction debris shredder and (b) dispersing the shredded debris at a construction site as mulch.

Somewhat more specifically, the method of the invention comprises the additional steps of placing the construction debris onto a feed conveyor operatively connected to a debris shredder enclosure and transporting the construction debris to the debris shredder enclosure prior to shredding the construction debris and conveying the shredded debris using a shredded debris conveyor from the debris shredder enclosure to a hopper for receiving and storing the shredded debris after the construction debris has been shredded and prior to dispersing the shredded debris, wherein the construction debris is shredded into the shredded debris using shredding equipment contained within the debris shredder enclosure.

Referring now to FIGS. 1 and 2, the mobile construction debris shredder 10 of the present invention is shown mounted on a truck 12. The preferred embodiment of the invention comprises five primary elements, namely, feed conveyor 14, debris shredder enclosure 16, rotating toothed drum 18, shredded debris conveyor 20, and hopper 22. As can be seen in FIG. 1, truck 12 comprises the transportation aspect of the invention 10, namely truck cab 24 for the driver, truck engine 26 for moving the invention 10 and for providing power to the operating systems of the invention 10, and truck frame 28 for supporting the components of the invention. More specifically, truck frame 28 supports the debris shredder enclosure 16 and the hopper 22, as well as directly or ultimately the rotating toothed drum 18, the shredded debris conveyor 20 and the various other components of the invention 10 as disclosed in more detail below. The debris shredder enclosure 16 preferably is located immediately behind the truck cab 24, and the hopper 22 preferably is located immediately behind the debris shredder enclosure 16, with the shredded debris conveyor 20 located in between the debris shredder enclosure 16 and the hopper 22.

Referring now to FIG. 3, in a preferred embodiment, the feed conveyor 14 is pivotably attached proximal to the debris shredder enclosure 16. When not in use, feed conveyor 14 can be pivoted or swung to lie alongside the invention 10, providing a streamlined configuration and enhancing the drivability and maneuverability of the truck 12 on the road and in confined spaces. The feed conveyor 14 is used to elevate and dump the debris 100 into an opening 32 in the top or top side of the shredding equipment component, namely the debris shredder enclosure 16. Preferably, the feed conveyor 14 is of the endless belt type and is movable from a storage position proximal to the truck 12 to an operating position extending from the truck 12 proximal to the debris 100 to be shredded. The feed conveyor 14 of a preferred embodiment generally comprises an endless belt 38, looped and traveling around rollers 40, and a belt motor 42 for imparting motion to the endless belt 38. The rollers 40 are rotatably secured within a frame 42 such that endless belt 38 can continuously travel about rollers 40. Belt motor 44 cooperates with endless belt 38 and/or rollers 40 to move endless belt 38. The endless belt 38 preferably can be operated in both directions; that is, in the feeding direction to move debris 100 up to the opening 32 proximal to the top of the debris shredder enclosure 16 and in the opposite direction to move debris 100 down away from the opening 32. This allows the operator both to feed debris 100 to the debris shredder enclosure 16 for shredding and to remove debris 100 away from the debris shredder enclosure 16 should this become necessary. Such endless belt conveyors are known in the art.

Referring now to FIG. 4, in its deployed or operating position, the feed conveyor 14 is attached to the debris shredder enclosure 16 or the truck 12 and extends from proximal to the opening 32 in the debris shredder enclosure 16 down to the debris 100 or to a level at which workers can load debris 100 onto the feed conveyor 14. The top end of feed conveyor 14 can be pivotably attached to the side of and/or proximal to the top of debris shredder enclosure 16 or to a support bar 48 securely attached to the invention 10. A brace arm 50 also can extend between debris shredder enclosure 16 or support arm 48 to feed conveyor 14 to provide added support for feed conveyor 14 and to lock feed conveyor 14 in the operating position. Such brace arms 50 are known. Debris 100 is loaded onto the feed conveyor 14 and the endless belt 38 transports the debris 100 up to the opening 32. The feed conveyor 14 can have ridges 34 or other protuberances or indentions to help prevent the debris 100 from sliding downwards while being conveyed. The opening 32 can have a safety door 36 to help prevent debris 100 or non-debris, such as the workers, from entering or falling into the debris shredder enclosure 16.

Referring now to FIG. 5, feed conveyor 14 is shown in the undeployed or non-operating position. As can be seen, in this position, feed conveyor 14 is proximal to the debris shredder enclosure 16 with brace arm 50 in a collapsed position. Brace arm 50 can be a solid component pivotably mounted to the debris shredder enclosure 16 or support bar 48 and slidably mounted to frame 42. Alternatively, brace arm 50 can be a telescoping component pivotably mounted to the debris shredder enclosure 16 or support bar 48 and pivotably or slidably mounted to frame 42.

It should be understood to those of skill in the art that rather than using an endless belt conveyor for deed conveyor 14, other lifting mechanisms can be used. For example, a screw auger, a cup or bucket conveyor, chain drive drag link conveyors, sliding surfaces, an elevator-type of lift, or an escalator-type of moving stair lift can be used. It should also be understood that even though the preferred embodiment of the feed conveyor 14 uses a hydraulic belt motor 44, feed conveyor 14 also can be operated with pneumatics or electronic actuation or with conventional electric motors.

Still referring to FIG. 5, debris shredder enclosure 16 minimally comprises a floor and surrounding walls to form a generally boxlike structure so as to be able to contain the shredding equipment and debris 100. Opening 32 at the top of debris shredder enclosure 16 allows debris 100 to be fed to the shredding equipment contained in the debris shredder enclosure 16. Opening 32 can be as simple as the open top of the debris shredder enclosure 16 to something more complex, such as safety door 36. For example, safety door 36 can be structured to remain closed unless and until debris 100 contacts safety door 36. Additionally, safety door 36 can be structured to provide for only a certain sized opening, thus allowing debris 100 to enter debris shredder enclosure 16, but preventing larger objects, such as people, from entering debris shredder enclosure 16. Those of ordinary skill in the art can design appropriate openings 32 and safety doors 36 without undue experimentation.

The shredding equipment is located and mounted within debris shredder enclosure 16. The shredding equipment can be any type of shredding equipment currently known or future developed that is capable of shredding the types of debris 100 contemplated, such as, for example purposes only, wood, wallboard, insulation, plastics, cardboard, crating materials, medium density fiberboard, and cementious boards. For example, current known shredders employing rotating toothed drums, rotating hammers, cutting discs, and interacting grinding wheels can be used. Preferably, such shredders should be able to handle from 700 to 2500+ pounds per hour of debris to be shredded to be efficient. Other handling capacities, such as from 0 to 700 pounds per hour and over 2500 pounds per hour, also can be suitable for smaller and larger scale shredders, respectively.

A preferred embodiment of the shredding equipment comprises a rotating toothed drum 18 coupled with a feeding ram 46. The feeding ram 46 pushes the debris 100 to the rotating toothed drum 18 and when the debris 100 contacts the rotating teeth 52 of the rotating toothed drum 18, the rotating teeth 52 shred the debris 100 to a desired size. The teeth 52 can be configured to direct the shredded debris 102 to a specific location within the debris shredder enclosure 16 for ease of manipulating the shredded debris 102 on to the next component of the invention 10. For example, if the teeth 52 are configured in rows or in a checkerboard pattern, the teeth 52 will act relatively evenly on the debris 100. However, if the teeth 52 are configured in a V-formation with a trailing apex, the debris 100 will be forced more towards the center of the rotating toothed drum 18, which can make the shredding action more efficient. As the rotating toothed drum 18 has a plurality of attachment sites for the teeth 52, the teeth 52 can be configured on the rotating toothed drum 18 as desired.

The teeth 52 can be manufactured out of any material suitable for shredding the debris 100. Steel and other metals, alloys, ceramics, composites, and diamond are representative materials satisfactory for the teeth 52. For some materials, such as steel, the teeth 52 can be hardened in conventional manners, such as heat annealing or cryogenic freezing. The teeth 52 can be removed and replaced when worn or with teeth 52 of a different size if a different shredded particle size is desired. For example, a smaller number of larger teeth 52 can result in larger shredded debris 102 particle size, while a greater number of smaller teeth 52 can result in smaller shredded debris 102 particle size. Additionally, different combinations of teeth 52 can be used, such as teeth 52 of different materials, sizes, heat treatments, etcetera, to achieve a desired level of shredding.

The shredding equipment further comprises the feed ram 46 and a feed plate 56, also mounted within the debris shredder enclosure 16. Feed plate 56 is a generally rectangular structure having a concave upwards surface that extends from relatively proximal to the opening 32 at its upper end to proximal to the rotating toothed drum 18 at its other end, and from the front side 16F to the rear side 16R of the debris shredder enclosure 16. Debris 100 being fed into the debris shredder enclosure 16 falls onto the feed plate 56 and is directed partly by gravity to the rotating toothed drum 18. The feed ram 46 cooperates with the feed plate 56 to force the debris 100 into contact with the rotating toothed drum 18. The feed ram 46 is rotatably mounted within the debris shredder enclosure 16 such that the feed ram 46 swings in an arc proximal and corresponding to the concave surface of the feed plate 56. The swing arc extends from at least a part of the way up the feed plate 56 to a position proximal to but not touching the rotating toothed drum 18.

A feed ram motor (shown in FIG. 9) provides the power for operating the feed ram 46, preferably in a pendulum-like motion. The feed ram motor preferably is controlled to actuate the feed ram 46 and to move the feed ram 46 forward to cause the feed ram 46 to push the debris 100 until a certain back pressure is measured, then to release and move the feed ram 46 backwards a certain distance, typically between 4 and 10 inches, and then to move the feed ram 46 forward again into the debris 100. It has been found that this cyclical actuation is useful to put sufficient pressure on the debris 100 so as to force the debris 100 against the rotating toothed drum 18 and to loosen any jam or bridging of the debris 100. Further, if some piece of debris 100 will not or cannot be shred, this may cause a jam and the resulting pressure spike on the feed ram 46 or the rotating toothed drum 18 can be sensed triggering the appropriate motor or motors to release or reverse.

Referring now to FIG. 7, the rotating toothed drum 18 is a generally cylindrical structure rotatably mounted within the debris shredder enclosure. The drum axis 54 preferably is horizontal relative to the truck frame 28 and extends in a direction from the front side 16F to the rear side 16R of debris shredder enclosure 16. Although the orientation of rotating toothed drum is of low importance, because feed conveyor 14 feeds debris 100 into debris shredder enclosure 16 from the left side 16L of debris shredder enclosure 16, by orienting the feed plate 56, the feed ram 46, and the rotating toothed drum 18 in such a manner as disclosed, the feed of the debris 100 to the rotating toothed drum 18 is more efficient, resulting in a more efficient shredding.

The shredded debris 102, when properly reduced in size, passes through a screen 30 comprising multiple screen openings 58. The screen 30 is located below the rotating toothed drum 18 and acts as a regulator for the particle size of the shredded debris 102. The screen 30 preferably is removable and replaceable, and the screen openings 58, or mesh size, can be selected as desired for different final sizes of the shredded debris 102. Shredded debris 102 of the desired size will pass through the screen 30, while shredded debris 102 larger than the desired size will remain on top of the screen 30 to be further acted upon by the rotating toothed drum 18 for further shredding.

More specifically, the screen 30 is mounted directly below the rotating toothed drum 18 and is the component for determining the size of the shredded debris 102 particle size. The screen 30 can be mounted by attaching the screen 30 to the sides of the debris shredder enclosure 16, by supports extending from the sides or the bottom of the debris shredder enclosure 16, or by combinations of these or other means. Alternatively, the screen 30 can be is mounted above or as the top of the shredded debris conveyor 20 so as to allow shredded debris 102 of only the desired size or smaller to pass into the shredded debris conveyor 20. Preferably, the screen 30 is mounted over the shredded debris conveyor 20 so as to serve as a platform for receiving the shredded debris 102 and for preventing shredded debris 102 of greater than the desired particle size from entering the shredded debris conveyor 20.

The screen 30 typically has a mesh-like or grid-like structure having crossing supports of sufficient strength to support a desired mass of shredded debris 102 and open spaces between the supports of a desired particle size for allowing the shredded debris 102 of the desired particle size or smaller to pass therethrough. Debris that is not shredded to a small enough size to pass through the open spaces remains on top of the screen 30 and is continuously acted upon by the teeth 52 until shredded to a size small enough to pass through the open spaces Debris that is not or can not be shredded to a small enough particle size can remain on top of the screen for later manual removal by an operator.

The shape of the screen 30 can be complimentary to the shape of the top of the shredded debris conveyor 20 compartment or, preferably, to the curvature of the rotating toothed drum 18, as shown in FIG. 5. With a shape corresponding to the curvature of the rotating toothed drum 18, more of the debris will be subjected to the teeth 52 for a longer period of time, resulting in greater debris shredding. The screen 30 also can be removable so as to allow the replacement of the screen 30 upon wear or breakage or to provide for the shredding of the debris into different larger or smaller particle sizes.

Once the debris has been shredded and passes through the screen 30, the shredded debris 102 falls into or is directed to the shredded debris conveyor 20. With the screen 30 located directly over the shredded debris conveyor 20, the shredded debris 102 can fall by gravity directly into the shredded debris conveyor 10. However, directional walls or baffles (not shown) can be included to direct the shredded debris 102 into the shredded debris conveyor 20. For example, such walls or baffles can extend upwardly from proximal to the edges of the first component casing 60 to proximal to the screen 30. For another example, such walls or baffles can flare out upwardly from proximal to the edges of the first component casing 60 to proximal to the screen 30 so as to direct more of the shredded debris 102 into the shredded debris conveyor 20.

Referring now to FIGS. 6 and 9, the shredded debris conveyor 20 preferably comprises two components or sections. The first component 70 is a generally horizontal conveyor that conveys the shredded debris 102 to the second component 72, which is a generally sloped conveyor that conveys the shredded debris 102 from the debris shredder enclosure 16 to the hopper 22. The first component 70 can be any type of conveyor equipment currently known or future developed that is capable of conveying the shredded debris 102 horizontally or generally horizontally including, but not limited to, endless belts systems and augers. The preferred first component 70 is a screw auger that conveys the shredded debris 102 passing through the screen 30 to the second component 72, or to an access device 74 leading to the second component 102, typically located at the rear of the debris shredder enclosure 16, between the debris shredder enclosure 16 and the hopper 22. The second component 72 also can be any type of conveyor equipment currently known or future developed that is capable of conveying the shredded debris 102 upwards or generally upwards including, but not limited to, endless belts systems, cup or bucket lifters, and augers. The preferred second component 72 also is a screw auger that conveys the shredded debris 102 upwards from the bottom of the debris shredder enclosure 16 to the top of the hopper 22.

One embodiment of the first component 70 of the shredded debris conveyor 20 is a horizontally mounted removal auger 76 mounted front to back proximal to the floor or bottom wall of the debris shredder enclosure 16. Preferably, first component casing 60, which can be a box-like structure containing removal auger 76, comprises side walls 62 for containing shredded debris 102 and for maintaining shredded debris 102 in conveying proximity to removal auger 76, such that removal auger 76 can convey shredded debris 102 in the desired direction. The bottom of side walls 62 may curve inwardly towards each other forming a generally round bottom having a curvature that corresponds with the circumference of removal auger 76 so as to even better provide for the conveyance of shredded debris 102 by removal auger 76. Generally, removal auger 76 has an axle that is journaled into bearings or supports mounted at either end of removal auger 76 and supports removal auger 76 at an appropriate height for proper operation. Alternatively, the removal auger 76 can have an incline from the front to the rear of the debris shredder enclosure 16 so as to provide a gravity assist in conveying the shredded debris 102 within the first component 70. Such removal augers 76 and first component casings 60 are known. For example, a standard 9-inch diameter screw auger operating at up to 200 revolutions per minute is suitable for removal auger 76.

The first component 70 of the shredded debris conveyor 20 conveys the shredded debris 102 from below the rotating toothed drum 18 to the second component 72 of the shredded debris conveyor 20, which typically is located outside of the debris shredding enclosure 16. A port 64 in the rear wall of the debris shredder enclosure 16 allows the exit of the shredded debris 102. Located outside of the debris shredder enclosure 16 and proximal to the port 64, and in receiving relationship to the port 64, is a receiving hopper 66 for receiving the shredded debris 102 and directing the shredded debris 102 to the second component 72 of the shredded debris conveyor 20. The receiving hopper 66 may be a part of the second component casing 68 or a separate element attached to or operatively connected to the second component casing 68. Shredded debris 102 exiting the first component 70 is conveyed into the receiving hopper 66 where it then is acted upon by the second component 72 of the shredded debris conveyor 20.

The second component 72 of the shredded debris conveyor 20 conveys the shredded debris 102 from the first component 70 at or proximal to the bottom of the debris shredder enclosure 16 up to or proximal to the top of the hopper 22. As can be seen in FIG. 2, hopper 22 and debris shredder enclosure 16 are two generally separate components, with second component 72 of shredded debris conveyor 20 extending between the two. One embodiment of the second component 72 of the shredded debris conveyor 20 is an angularly mounted lifting auger 76 mounted at a rising angle from the front of the truck 12 to the back of the truck 12 proximal to the rear wall of the debris shredder enclosure 16 and the front wall of the hopper 22. Preferably, second component casing 72 is a cylinder-like structure containing lifting auger 78 for containing shredded debris 102 and for maintaining shredded debris 102 in conveying proximity to lifting auger 78, such that lifting auger 78 can convey shredded debris 102 in the desired direction. The cylinder-like structure of second component casing 72 preferably has a curvature that corresponds with the circumference of lifting auger 78 so as to provide for the conveyance of shredded debris 102 by lifting auger 78. Generally, lifting auger 78 has an axle that is journaled into bearings or supports mounted at either end of second component casing 72 and supports lifting auger 78 at an appropriate angle for proper operation. Such lifting augers 78 and second component casings 72 are known. For example, a standard 9-inch diameter pitch screw auger operating at up to 200 revolutions per minute also is suitable for lifting auger 78. The orientation angle of lifting auger 78 is dependent on the heights of and spacing between debris shredder enclosure 16 and hopper 22, and typically is in the 45° to 90° range from horizontal.

As the shredded debris 102 is introduced to the second component 72, the shredded debris 102 is conveyed by the lifting auger 78 upwardly from the debris shredder enclosure 16 to the hopper 22. At the upper end of second component casing 68, which is the end at or proximal to the hopper 22, the shredded debris 102 is deposited into the hopper 22 via an exit port 94. The action of the lifting auger 78 moving shredded debris 102 can force the shredded debris 102 out of the second component casing 72 through the exit port 94. Alternatively and additionally, the exit port 94 can have a downwardly angled structure to assist in depositing the shredded debris 102 into the hopper 22.

Alternatively, the shredded debris conveyor 20 can be one component with two sections or a single component. For example, the shredded debris conveyor 20 can be a generally unitary structure having a first section comprising a removal auger 76 or an equivalent removal means and a second section comprising a lifting auger 78 or an equivalent lifting means. In this embodiment, rather than passing the shredded debris 102 from the first component 70 to the second component 72, the shredded debris 102 is passed within the single component from the removal auger 76 or an equivalent removal means to the lifting auger 78 or an equivalent lifting means. For another example, the shredded debris conveyor 20 can be a single conveyance means having an angle corresponding to the transition from the first component 70 to the second component 72. Such angled conveyance means incorporating a first section conveying horizontally and a second section conveying at an incline or decline are known in the art. For still another example, if there is sufficient room in the debris shredder enclosure 16 and between the debris shredder enclosure 16 and the hopper 22, a single inclined conveyance means can be used.

Referring now to FIG. 8, the hopper 22 is for storing the shredded debris 102 and preferably is a separate component or enclosure located proximal to, and preferably behind the debris shredder enclosure 16 relative to the front of the truck 12. This configuration allows for greater ease and flexibility in dumping or dispersing the shredded debris 102. The hopper 22 generally is an enclosure adapted for receiving and storing the shredded debris 102 and minimally comprises a floor and surrounding walls. The second component 72 of the shredded debris conveyor 20 dumps the shredded debris 102 into a hopper opening 80 at the top of the hopper 22. The hopper 22 can further comprise a device for removing metallics 82 or other undesirable materials from the shredded debris 102, as well as devices for more evenly distributing 84 the shredded debris 102 within the hopper 22. Further, the hopper 22 can comprise a live floor 86 both for more evenly distributing the shredded debris 102 within the hopper 22 and for dumping or dispersing the shredded debris 102 from the hopper 22.

More specifically, second component casing 72, and preferably exit port 94, cooperates with hopper opening 80 so as to allow the shredded debris 102 to be deposited into the hopper 22. To accomplish this hopper opening 80 can be a port through a top wall or side wall of the hopper 22, or merely the open top of the hopper 22. At the simplest, the shredded debris 102 is deposited directly into the hopper 22, falling by gravity to the bottom of the hopper 22. From there, the shredded debris 102 can be removed from the hopper 22 via a selected manual or automatic means. To assist in such removal, hopper 22 can have sloped sides 96 to direct the shredded debris 102 away from the sides of the hopper 22 and towards the center of the hopper 22, and to reduce the likelihood that the shredded debris 102 will accumulate and remain in the lower corners of the hopper 22.

Preferably, however, the hopper 22 comprises a removal device 98 for eliminating the shredded debris 102 from the hopper 22. Such a removal device 98, also sometimes called a live bottom, is mounted at the bottom of the hopper 22 such that the removal device 98 can act upon the shredded debris 102 deposited in the hopper 22. The removal device 98 can, for example, be a conveyor belt, a series of rotating paddles, or, preferably, one or more screw augers such as debris augers 110. In the embodiment shown in FIG. 8, a plurality of debris augers 110 are horizontally mounted in a parallel fashion proximal to the bottom of the hopper 22. Debris augers 110 preferably are mounted with their axles extending front to back relative to the truck frame 28. Preferably, a shaped platform 112 is located underneath the debris augers 110 for maintaining shredded debris 102 in conveying proximity to debris augers 110, such that debris augers 110 can convey shredded debris 102 in the desired direction. The shaped platform 112 preferably curves concave upwards relative to each debris auger 110 forming a generally wave-like structure having curvatures that correspond with the circumferences of debris augers 110 so as to even better provide for the conveyance of shredded debris 102 by debris augers 110.

Alternatively, the bottom of hopper 22 can slope downwardly and inwardly towards a single debris auger 110 horizontally mounted proximal to the bottom of the hopper 22. In this embodiment, debris auger 110 also preferably is mounted with its axle extending front to back relative to the truck frame 28, and preferably along the front to back centerline of the hopper 22, where the lower vertex created by the sloped bottom of the hopper 22 preferably is located. In this embodiment, the sloped walls would direct the shredded debris 102 to the single debris auger 110, such that debris auger 110 can convey shredded debris 102 in the desired direction. Additionally, in this embodiment, the bottom of the sloped walls may curve inwardly towards each other forming a generally round bottom having a curvature that corresponds with the circumference of debris auger 110 so as to even better provide for the conveyance of shredded debris 102 by debris auger 110.

Generally, debris augers 110 have axles that are journaled into bearings or supports mounted at either end of debris augers 110 and support debris augers 110 at an appropriate height for proper operation. Alternatively, the debris augers 110 can have an incline in a desired direction, namely the direction of desired conveyance of the shredded debris 102 for removal from the hopper 22, so as to provide a gravity assist in conveying the shredded debris 102 within the hopper 22. Such debris augers 110 are known. For example, standard 9-inch diameter pitch screw augers operating at up to 200 revolutions per minute are suitable for debris augers 110.

Various alternatives to screw augers are suitable. For example, one or more endless belt conveyors can be substituted for the augers. However, due to the general ruggedness of a screw auger compared to an endless belt conveyor, a screw auger is preferred. For another example, one or more paddle wheels or rotating drums having paddles can be substituted for the augers. While such paddle wheels and rotating drums having paddles can be as rugged as screw augers, a screw auger is simpler and is preferred.

Debris augers 110 also can be used to more evenly distribute the shredded debris 102 within the hopper 22. As the shredded debris 102 is deposited into the hopper 22, it typically will form a pyramidal pile. The debris augers 110 can be operated in both rotational directions (clockwise and counterclockwise) and alternating between the two directions can have the effect of moving, shifting or shaking the pile of shredded debris 102 so as to more evenly spread the shredded debris 102 over the bottom of the hopper 22. Similarly, a single debris auger 110, a belt conveyor, paddle wheels and rotating drums having paddles can be used to the same result.

The hopper 22 also can comprise a precursor device 122 for more evenly depositing the shredded debris 102 into the hopper 22. As disclosed previously, as the shredded debris 102 is deposited into the hopper 22, it typically will form a pyramidal pile. A precursor device 122 can be located immediately below the hopper opening 80 such that shredded debris 102 exiting the second component 72 into the hopper 22 first will encounter the precursor device 122, which will move or shift the shredded debris 102 so as to more evenly fill the hopper 22. For example, precursor device 122 can be a screw auger horizontally mounted proximal to the top of the hopper 22 and extending from the front to the middle or back of the hopper 22. Shredded debris 102 would fall onto the precursor device 122 auger and be moved towards the back of the hopper 22, thus more evenly distributing the shredded debris 102 in the hopper 22. A precursor device 122 also can be used in combination with a live bottom. A static precursor device 122, such as baffles or the like located below the hopper opening 80, also can achieve a satisfactory result.

Alternatively, the precursor device 122 can be a device for more evenly distributing 84 the shredded debris 102. the device for more evenly distributing 84 acts upon the shredded debris 102 as it piles up in the hopper 22. As the shredded debris 102 is deposited in the hopper 22, it forms a pyramidal pile. As this pile grows, it reaches closer to the top of the hopper and comes into contact with the device for more evenly distributing 84, which then moves, directs or diverts at least some of the shredded debris 102 from the top of the pile, generally towards the back of the hopper 22.

The hopper 22 also can comprise a device for removing metallics 82 from the shredded debris 102. In its preferred form, the device for removing metallics 82 is configured to remove ferrous metals, such as nails, screws and bolts, as ferrous metals often are the predominant metallics in most situations. The device for removing metallics 82 shown in FIG. 8 comprises a non-metallic or metallic, but preferably non-magnetic, rotating steel drum 114 having an internal magnet 116. Shredded debris 102 exiting the second component 72 into the hopper 22 will encounter the device for removing metallics 82 prior to falling to the hopper 22 floor. The magnet 116 is located in only one half of the interior of the steel drum 114, namely the half that the shredded debris 102 encounters. The magnetic field created by the magnet 116 extends through the steel drum 114 causing ferrous metallics in the shredded debris 102 to stick to the steel drum 114. As the steel drum 114 rotates, the surface of the steel drum 114 alternately is proximal to the magnet 116 and is distal to the magnet 116. When the surface of the steel drum 114 is distal from the magnet 116, the magnetic field is not strong enough to hold the ferrous metallics on the steel drum 114 and the ferrous metallics fall off into a waste bin 118.

Many variations of such a device for removing metallics 82 are suitable, from a simple magnet that must be manually cleaned to a rotating magnet with a doctor blade for removing the metallics to a screen, static or dynamic, with a mesh size small enough to allow nails and the like, but not shredded debris 102, to pass therethrough. A simple magnet located below the hopper opening 80 would attract metallics from the shredded debris 102 falling into the hopper 22. An operator periodically would have to clean the surface of the magnet. A rotating magnet and doctor blade combination would include a rotating preferably cylinder-shaped magnet rotating much in the same way as the steel drum 114 previously disclosed. This rotating magnet also would be located below the hopper opening 80 also would attract metallics from the shredded debris 102 falling into the hopper 22. A doctor blade abutting the rotating magnet would scrape the metallics off of the magnet into a waste bin 118.

Referring now to FIG. 10, shredded debris 102 exits the hopper 22 through a removal port 88. The port 88 can range from a simple opening to a more complex spreading device 90. Minimally, the port 88 should allow the shredded debris 102 to be dumped or dispersed from the hopper 22. Exit ports also can be located on any of the sides of the hopper 22 if so desired.

In the embodiment shown in FIG. 8, removal port 88 is at the bottom of the front wall of the hopper 22, and thus facing debris shredder enclosure 16. Therefore, in the embodiment shown in FIG. 8, the shredded debris 102 is conveyed towards the front of the hopper 22 and out through removal port 88 to the spreading device 120. In this embodiment, the shredded debris 102 is conveyed across the floor of the hopper 22 by the live floor, namely the debris augers 110, to removal port 88 and onto spreading device 90. Spreading device 90 then can be used to distribute the shredded debris 102 onto the ground as mulch or a ground cover or to dispose of the shredded debris 102 into a disposal site, such as a landfill.

As shown in FIGS. 2 and 8, spreading device 90 comprises a transverse auger 124 and a pivot auger 126. One embodiment of the transverse auger 124 is a horizontally mounted screw auger mounted transversely side to side proximal to the truck frame 28 immediately in front of the hopper 22. The transverse auger 124 preferably is at least partially enclosed in a first cylindrical casing 128 for containing shredded debris 102 and for maintaining shredded debris 102 in conveying proximity to transverse auger 124, such that transverse auger 124 can convey shredded debris 102 in the desired direction. Generally, transverse auger 124 has an axle that is journaled into bearings or other supports mounted at either end of transverse auger 124 and supports transverse auger 124 at an appropriate position for proper operation. Alternatively, the transverse auger 124 can have an incline from a first end to a second end so as to provide a gravity assist in conveying the shredded debris 102, with the shredded debris being conveyed in the direction of from the first end to the second end.

One embodiment of the pivot auger 126 is a screw auger pivotally mounted on the side of the truck 12 proximal to a front side corner of the hopper 22 and in conveying relationship to the transverse auger 124. The pivot auger 126 also preferably is at least partially enclosed in a second cylindrical casing 130 for containing shredded debris 102 and for maintaining shredded debris 102 in conveying proximity to pivot auger 126, such that pivot auger 126 can convey shredded debris 102 in the desired direction. Generally, pivot auger 126 has an axle that is journaled into bearings or supports mounted at either end of pivot auger 126 and supports pivot auger 126 at an appropriate position for proper operation. Pivot auger 126 is mounted on the truck 12 such that pivot auger 126 can be pivoted from a resting position alongside the truck 12, providing a streamlined configuration and enhancing the drivability and maneuverability of the truck 12 on the road and in confined spaces, to a deployed or operating position extending outwardly from the truck 12.

A first input end of pivot auger 126 lies proximal to and in operational relationship with the second end of transverse auger 124. More specifically, transverse auger 124 conveys the shredded debris 102 in a direction towards pivot auger 126 such that when shredded debris 102 reaches the second end of transverse auger 124, shredded debris 102 then transfers onto pivot auger 126 via the first input end, and then is conveyed by pivot auger 126 to second output end for spreading on the ground as mulch or a ground cover. To assist in the transfer of the shredded debris 102 from transverse auger 124 to pivot auger 126, first cylindrical casing 128 can structurally cooperate with second cylindrical casing 130 when pivot auger 126 is in the operating or deployed position such that first cylindrical casing 128 and second cylindrical casing 130 can fit together to make a more or less continuous structure for conveying shredded debris 102. Such structures are known, such as the multi-pieced output chutes used on a common cement truck.

Transverse augers 124, pivot augers 126, first cylindrical casings 128, and second cylindrical casings 130 are known. For example, a standard 9-inch diameter screw auger operating at up to 200 revolutions per minute is suitable for transverse auger 124 and pivot auger 126.

Second cylindrical casing 130 preferably is of such a length to extend outwardly from the truck 12 a sufficient distance to deliver the shredded debris 102 to a desired location on the ground. For example, second cylindrical casing 130 preferably is of such a length that truck 12 can be parked on the street and second cylindrical casing 130 can extend over a sidewalk, low fence and/or silt fence and still deliver the shredded debris 102. Further, it is preferable if second cylindrical casing 130 is pivotable horizontally to a certain extent to facilitate the delivery of the shredded debris 102 to a desired location.

Similar to the shredded debris conveyor 20, the spreading device 90 can be one component with two sections or a single component. For example, the spreading device 90 can be a generally unitary structure having a first section comprising a transverse auger 124 or an equivalent conveyance means and a second section comprising a pivot auger 126 or an equivalent depositing means. In this embodiment, rather than passing the shredded debris 102 from the first casing 128 to the second casing 130, the shredded debris 102 is passed within the single component from the first section comprising the transverse auger 124 or an equivalent conveyance means to the second section comprising the pivot auger 126 or an equivalent depositing means. In such an embodiment, it would be preferable to have at least a hinge and/or a pivoting connection between the first section and the second section to enhance the spreading ability of the spreading device 90.

The various powered components of the invention 10 can be powered by electric motors, hydraulic motors, the truck engine 26, or any other known or future developed power source suitable for such motors. Preferably, the invention 10 comprises a common hydraulic power system comprising pumps, tubes and power units (motors) and each of the powered components of the invention preferably has its own power unit. The driving power for the hydraulics preferably is supplied by the truck engine 26 utilizing a conventional power take off design. More specifically, a single hydraulic pump 92 can be used to supply hydraulic fluid under pressure to the various hydraulic motors 104 of the invention 10 or, preferably, one hydraulic pump 92 can be used for the rotating toothed drum 18 and a second hydraulic pump 92 can be used for the other components of the invention 10 due to the significant power requirements of the rotating toothed drum. One or more hydraulic fluid reservoirs 106 can be used to hold the hydraulic fluid. As mentioned above, it is preferable to have a separate hydraulic motor 104 for each of the powered components, such as feed conveyor 14, rotating toothed drum 18, shredded debris conveyor 20, and all of the augers or their equivalents. The invention 10 further comprises conventional controls for the various motors, lifters, augers, etcetera of the invention, and can be operated by manual controls or automatically using a programmed microprocessor. Gear reducers (not shown) also can be used to produce the required power, especially if electric or fossil fuel (diesel, kerosene, gasoline, biodiesel, etcetera) engines are used.

In operation and use, the invention 10 is a system and device, and a method for implementing the system and device, comprising a mobile shredder for on-site shredding of construction debris 100 for reuse as mulch, the device allowing one to load construction debris 100 onto the shredder, the shredding of the construction debris 100, and the distributing of the shredded debris 102 as mulch onto the site preferably without disturbing the environmental controls, such as silt fences.

The invention 10 is driven to a construction site having debris 100 to be shredded. Due to the size of the invention 10, it can easily be maneuvered at the construction site to a location proximal to the debris 100. The feed conveyor 14 is pivoted from its resting position alongside the debris shredder enclosure 16 to its conveying position in which a first end of the feed conveyor 14 is proximal to the opening 32 at the top of the debris shredder enclosure 16 down to a second end of the feed conveyor 14 that is distal from the truck 12 but is relatively proximal to the debris 100. Preferably, the feed conveyor 14 extends over any silt fence or other environmental controls on the site. The feed conveyor 14 is actuated so as to start endless belt 38 moving in a direction that allows for the debris 100 to be conveyed along the feed conveyor 14 to the opening 32. The workers load the debris 100 onto the feed conveyor 14, which transports the debris 100 into the debris shredder enclosure 16 from the side of the truck 12. Safety door 36, if present, is opened manually or automatically to allow the debris 100 into the debris shredder enclosure 16. Safety door 36 can be opened manually by a worker or automatically by the weight of the debris 100, or in other ways currently known or future developed.

As the feed conveyor 14 feeds the debris 100 into the debris shredder enclosure 16 from the side, it has been found to be more efficient to have the rotating toothed drum 18 mounted horizontally within the debris shredder enclosure 16 such that the axis of rotation of the rotating toothed drum 18 is horizontal relative to the truck frame 28 and extends from the front side to the back side of the debris shredder enclosure 16 relative to the truck frame 28. The feed conveyor 14 deposits the debris 100 into the debris shredder enclosure 16 where it falls onto the rotating toothed drum 18 and the feed plate 56. The feed ram 46, which preferably operates automatically in a cyclical back and forth or pendulum fashion, forces the debris 100 into contact with the rotating toothed drum 18, specifically onto the screen 30 located generally beneath the rotating toothed drum 18. The teeth 52 act upon the debris 100 shredding the debris 100 into smaller and smaller particles. Shredded debris 102 of a desired particle size or smaller falls through the screen openings 58 and onto the shredded debris conveyor 20.

The first component 70 of the shredded debris conveyor 20 conveys the shredded debris 102 through the port 64 in the rear wall of the debris shredder enclosure 16 to the second component 72. If present, the receiving hopper 66 helps guide the shredded debris 102 into the second component 72, which conveys the shredded debris 102 upwardly to the hopper 22. when the shredded debris 102 reaches the upper end of the second component 72, it is deposited into the hopper 22, typically through the hopper opening 80.

As the hopper 22 is located behind the debris shredder enclosure 16, the first component 70 of the shredded debris conveyor 20 preferably is mounted horizontally below the screen 30 such that the axis of rotation and/or direction of movement of the first component 70 is horizontal relative to the truck frame 28 and extends front to back relative to the truck frame 28. The second component 72 of the shredded debris conveyor 20 is mounted between the debris shredder enclosure 16 and the hopper 22 at an angle or vertically so as to allow the conveyance of the shredded debris 102 from the bottom of the debris shredder enclosure 16 to the top of the hopper 22. As such, the axis of rotation and/or direction of movement of the second component 72 is angled upward and rearward, or vertical, relative to the truck frame 28.

The shredded debris 102, upon entering the hopper 22, encounters the device for removing metallics 82 and/or the device for more evenly distributing 84 the shredded debris 102, in either order. The device for removing metallics 82 removes metallic pieces, such as nails and other fasteners, from the shredded debris 102. The device for more evenly distributing 84 the shredded debris 102 helps to more evenly distribute the shredded debris 102 within the hopper 22. The shredded debris 102 then is retained within the hopper 22. While in the hopper 22, the live floor 86 can move and shift the shredded debris 102 also to more evenly distribute the shredded debris 102 within the hopper 22 so as to allow more shredded debris 102 to be retained in the hopper 22.

When it is desired to empty the hopper 22 of the shredded debris 102, the debris augers 110 are actuated to convey the shredded debris 102 out through the removal port 88 and to the spreading device 120. More specifically, the shredded debris 102 first is conveyed to the transverse auger 124 where the shredded debris 102 is conveyed transversely relative to the truck frame 28 towards a side of the truck 12. Generally prior, but also possibly contemporaneously, the pivot auger 126 is pivoted from its resting position generally proximal to the hopper 22 to its conveying position in which the first input end of the pivot auger 126 is proximal to and extends from the second end of the transverse auger 124 down to the second output end of the pivot auger 126 that is distal from the truck 12. Preferably, the pivot auger 126 extends over the silt fence or other environmental controls on the site. The shredded debris 102 is conveyed from the transverse auger 124 to the pivot auger 126 and deposited on the ground as mulch or other ground covering.

In addition to the general method steps disclosed above, the invention 10 can comprise one or more of the following additional method steps:
(a) Shredding the construction debris 100 using a rotating toothed drum 18 shredder.
(b) Removing and replacing the removable teeth 52 on the rotating toothed drum 18 as the removable teeth 52 become worn.
(c) Using a V-formation of teeth 52 with the apex of the formation in a trailing position whereby the construction debris 100 is urged inwardly towards the apex of the formation.
(d) Screening the shredded debris 102, prior to conveying the shredded debris 102 from the debris shredder enclosure 16 to the hopper 22, using a screen 30, wherein the screen 30 comprises sieve gaps of a selected size through which the shredded debris 102 can pass to the shredded debris conveyor 20.
(e) Sizing the shredded debris 102 using the screen 30, wherein if the shredded debris 102 is larger than a selected particle size, then the shredded debris 102 will remain on the screen 30 for further shredding, and if the shredded debris 102 is smaller than the selected particle size, then the shredded debris 102 will pass through the sieve gaps to the shredded debris conveyor 20, the selected particle size corresponding to the selected size of the sieve gaps.
(f) Removing and replacing the screen 30 with an alternate screen 30 having a different sieve gap size so as to produce shredded debris 102 or mulch of a different selected size.
(g) Feeding the construction debris 100 to the debris shredding equipment using a feed plate 56 and a ram 46, wherein the construction debris 100 to be shredded at least partly falls onto the feed plate 56 and the ram 46 forces the construction debris 100 to be shredded to the debris shredding equipment.
(h) More evenly distributing the shredded debris 102 within the hopper 22 using a live floor 86 proximal to the bottom of the hopper 22 and/or using a precursor device 122 located proximal to the top of the hopper 22.
(i) Removing the shredded debris 102 from the hopper 22 using a removal device located proximal to the bottom of the hopper 22.
(j) Removing metal, such as ferrous metal, from the shredded debris 102 prior to the shredded debris 102 being deposited in the hopper 22.
(k) Extending the feed conveyor 14 a distance from the debris shredder enclosure 16 to a pile of the debris 100 to be shredded that is located distal from the mobile construction debris shredder 10 and over any environmental controls located between the pile of the debris 100 to be shredded and the mobile construction debris shredder 10.
(l) Moving the feed conveyor 14 from a resting position proximal to the debris shredder enclosure 16 to an operating position extending from the top of the debris shredder enclosure 16 down to a pile of the debris 100 to be shredded.
(m) Using a spreading device 90 operatively connected to the hopper 22 for receiving the shredded debris 102 from the hopper 22 and for the dispersing of the shredded debris 102.
(n) Moving the spreading device 90 from a resting position proximal to the mobile construction debris shredder 10 to an operating position extending from the mobile construction debris shredder 10 to a location for depositing the shredded debris 102 and over any environmental controls located between the location for depositing the shredded debris 102 and the mobile construction debris shredder 10.
(o) Transporting the mobile construction debris shredder 10 on a truck 12.
(p) Moving the truck 12 from a first site location at which the construction debris 100 is obtained to a second site at which the shredded debris 102 is dispersed.

Other steps also can be included as desired by the operator of the device, and the invention is not limited to the disclosed steps.

The above detailed description of the preferred embodiments, examples, and the appended figures are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

List of Designations

| No. | Designation |
|---|---|
| 10 | Device |
| 12 | Truck |
| 14 | Feed conveyor |
| 16 | Debris shredder enclosure |
| 18 | Rotating toothed drum |
| 20 | Shredded debris conveyor |
| 22 | Hopper |
| 24 | Truck cab |
| 26 | Truck engine |
| 28 | Truck frame |
| 30 | Screen |
| 32 | Opening |
| 34 | Ridges |
| 36 | Safety door |
| 38 | Endless belt |
| 40 | Rollers |
| 42 | Frame |
| 44 | Belt motor |
| 46 | Ram |
| 48 | Support bar |
| 50 | Brace arm |
| 52 | Teeth |
| 54 | Drum axle |
| 56 | Feed plate |
| 58 | Screen openings |
| 60 | First component casing |
| 62 | First component casing side walls |
| 64 | Port |
| 66 | Receiving hopper |
| 68 | Second component casing |
| 70 | First component |
| 72 | Second component |
| 74 | Access device |
| 76 | Removal auger |
| 78 | Lifting auger |
| 80 | Hopper opening |
| 82 | Device for removing metallics |
| 84 | Device for more evenly distributing |
| 86 | Live floor |
| 88 | Removal port |
| 92 | Hydraulic pump |
| 94 | Exit port |
| 96 | Sloped sides |
| 98 | Removal device |
| 100 | Debris |
| 102 | Shredded debris |
| 104 | Hydraulic motor |
| 106 | Hydraulic fluid reservoir |
| 110 | Debris auger |
| 112 | Shaped platform |
| 114 | Steel drum |
| 116 | Magnet |
| 118 | Waste bin |
| 120 | Spreading device |
| 122 | Precursor device |
| 124 | Transverse auger |
| 126 | Pivot auger |
| 128 | First cylindrical casing |
| 130 | Second cylindrical casing |

What is claimed is:

1. A mobile construction debris shredder system, comprising:
(a) A debris shredder enclosure for receiving construction debris to be shredded;
(b) a feed conveyor operatively connected to the debris shredder enclosure for transporting the construction debris to be shredded to the debris shredder enclosure;
(c) debris shredding equipment contained within the debris shredder enclosure for shredding the construction debris into shredded debris;
(d) a hopper for receiving and storing the shredded debris; and
(e) a shredded debris conveyor for conveying the shredded debris from the debris shredder enclosure to the hopper.

2. The mobile construction debris shredder as claimed in claim 1, wherein the debris shredding equipment comprises a rotating toothed drum shredder.

3. The mobile construction debris shredder as claimed in claim 2, wherein the toothed drum shredder comprises a plurality of removable teeth.

4. The mobile construction debris shredder as claimed in claim 2, wherein the toothed drum comprises a plurality of teeth mounted on the toothed drum in a V-formation with the apex of the formation in a trailing position.

5. The mobile construction debris shredder as claimed in claim 1, wherein the debris shredding equipment comprises a screen for screening the shredded debris, wherein the screen comprises sieve gaps of a selected size through which the shredded debris can pass to the shredded debris conveyor.

6. The mobile construction debris shredder as claimed in claim 5, wherein if the shredded debris is larger than a selected particle size, then the shredded debris will remain on the screen for further shredding, and if the shredded debris is smaller than the selected particle size, then the shredded debris will pass through the sieve gaps to the shredded debris conveyor, the selected particle size corresponding to the selected size of the sieve gaps.

7. The mobile construction debris shredder as claimed in claim 5, wherein the screen is removable and replaceable with alternate screens having different sieve gap sizes.

8. The mobile construction debris shredder as claimed in claim 1, wherein the debris shredder enclosure further comprises a feed plate and a ram for feeding the construction debris to be shredded to the debris shredding equipment, wherein the construction debris to be shredded at least partly falls onto the feed plate and the ram forces the construction debris to be shredded to the debris shredding equipment.

9. The mobile construction debris shredder as claimed in claim 1, wherein the hopper comprises a live bottom for more evenly distributing the shredded debris within the hopper.

10. The mobile construction debris shredder as claimed in claim 9, wherein the live bottom comprises at least one screw auger.

11. The mobile construction debris shredder as claimed in claim 1, wherein the hopper comprises a removal device for removing the shredded debris from the hopper.

12. The mobile construction debris shredder as claimed in claim 11, wherein the removal device is located proximal to the bottom of the hopper.

13. The mobile construction debris shredder as claimed in claim 12, wherein the removal device comprises at least one auger.

14. The mobile construction debris shredder as claimed in claim 1, wherein the hopper comprises a precursor device for more evenly distributing the shredded debris within the hopper.

15. The mobile construction debris shredder as claimed in claim 14, wherein the precursor device is located proximal to the top of the hopper.

16. The mobile construction debris shredder as claimed in claim 15, wherein the precursor device comprises at least one auger.

17. The mobile construction debris shredder as claimed in claim 1, further comprising a device for removing metal from the shredded debris prior to the shredded debris being deposited in the hopper.

18. The mobile construction debris shredder as claimed in claim 17, wherein the metal is ferrous metal and the device for removing metal comprises a magnet.

19. The mobile construction debris shredder as claimed in claim 1, wherein the shredded debris conveyor comprises at least one screw auger.

20. The mobile construction debris shredder as claimed in claim 1, wherein the debris shredder enclosure further comprises a safety door between the feed conveyor and the debris shredding equipment.

21. The mobile construction debris shredder as claimed in claim 1, wherein the feed conveyor has a length sufficient to extend from the debris shredder enclosure to a pile of the debris to be shredded that is located distal from the mobile construction debris shredder and over any environmental controls located between the pile of the debris to be shredded and the mobile construction debris shredder.

22. The mobile construction debris shredder as claimed in claim 1, wherein the feed conveyor is movable from a vertical resting position proximal to the debris shredder enclosure to an angled operating position extending from the top of the debris shredder enclosure down to a pile of the debris to be shredded.

23. The mobile construction debris shredder as claimed in claim 1, further comprising a spreading device operatively connected to the hopper for receiving the shredded debris from the hopper and for depositing the shredded debris onto a location for depositing the shredded debris.

24. The mobile construction debris shredder as claimed in claim 23, wherein the spreading device has a length sufficient to extend from the hopper to a location for depositing the shredded debris distal from the mobile construction debris shredder and over any environmental controls located between the location for depositing the shredded debris and the mobile construction debris shredder.

25. The mobile construction debris shredder as claimed in claim 23, wherein the spreading device is movable from a vertical resting position proximal to the mobile construction debris shredder to an operating position extending from the mobile construction debris shredder to the location for depositing the shredded debris.

26. The mobile construction debris shredder as claimed in claim 1, further comprising a truck on which the mobile construction debris shredder is mounted.

27. A mobile construction debris shredder system, comprising:
(a) A debris shredder enclosure for receiving construction debris to be shredded;
(b) a feed conveyor operatively connected to the debris shredder enclosure for transporting the construction debris to be shredded to the debris shredder enclosure;
(c) debris shredding equipment contained within the debris shredder enclosure for shredding the construction debris into shredded debris, wherein the debris shredding equipment comprises:
(i) a rotating toothed drum having a plurality of shredding teeth;
(ii) a screen for screening the shredded debris, the screen having sieve gaps of a selected size through which the shredded debris can pass to the shredded debris conveyor; and
(iii) a feed plate and a ram for feeding the construction debris to be shredded to the debris shredding equipment, wherein the construction debris to be shredded at least partly falls onto the feed plate and the ram forces the construction debris to be shredded to the debris shredding equipment;
(d) a hopper for receiving and storing the shredded debris;
(e) a shredded debris conveyor for conveying the shredded debris from the debris shredder enclosure to the hopper;
(f) a spreading device operatively connected to the hopper for receiving the shredded debris from the hopper and for depositing the shredded debris onto a location for depositing the shredded debris; and
(g) a truck on which the mobile construction debris shredder is mounted.

28. The mobile construction debris shredder as claimed in claim 27, wherein the toothed drum shredder comprises a plurality of removable teeth mounted on the toothed drum in a V-formation with the apex of the formation in a trailing position.

29. The mobile construction debris shredder as claimed in claim 27, wherein if the shredded debris is larger than a selected particle size, then the shredded debris will remain on the screen for further shredding, and if the shredded debris is smaller than the selected particle size, then the shredded debris will pass through the sieve gaps to the shredded debris conveyor, the selected particle size corresponding to the selected size of the sieve gaps.

30. The mobile construction debris shredder as claimed in claim 27, wherein the screen is removable and replaceable with alternate screens having different sieve gap sizes.

31. The mobile construction debris shredder as claimed in claim 27, wherein the hopper comprises a live bottom having at least one auger for more evenly distributing the shredded debris within the hopper.

32. The mobile construction debris shredder as claimed in claim 27, wherein the hopper comprises a removal device, located proximal to the bottom of the hopper, for removing the shredded debris from the hopper.

33. The mobile construction debris shredder as claimed in claim 27, wherein the hopper comprises a precursor device, located proximal to the top of the hopper, for more evenly distributing the shredded debris within the hopper.

34. The mobile construction debris shredder as claimed in claim 27, further comprising a magnetic device for removing ferrous metal from the shredded debris prior to the shredded debris being deposited in the hopper.

35. The mobile construction debris shredder as claimed in claim 27, wherein the debris shredder enclosure further comprises a safety door between the feed conveyor and the debris shredding equipment.

36. The mobile construction debris shredder as claimed in claim 27, wherein:
the feed conveyor has a length sufficient to extend from the debris shredder enclosure to a pile of the debris to be shredded that is located distal from the mobile construction debris shredder and over any environmental controls located between the pile of the debris to be shredded and the mobile construction debris shredder; and
the spreading device has a length sufficient to extend from the hopper to a location for depositing the shredded debris distal from the mobile construction debris shredder and over any environmental controls located between the location for depositing the shredded debris and the mobile construction debris shredder.

37. The mobile construction debris shredder as claimed in claim 36, wherein:
the feed conveyor is movable from a vertical resting position proximal to the debris shredder enclosure to an angled operating position extending from the top of the debris shredder enclosure down to a pile of the debris to be shredded; and
the spreading device is movable from a vertical resting position proximal to the mobile construction debris shredder to an operating position extending from the mobile construction debris shredder to the location for depositing the shredded debris.

38. A mobile construction debris shredder system, comprising:
(a) A debris shredder enclosure for receiving construction debris to be shredded;
(b) a feed conveyor operatively connected to the debris shredder enclosure for transporting the construction debris to be shredded to the debris shredder enclosure;
(c) debris shredding equipment contained within the debris shredder enclosure for shredding the construction debris into shredded debris, wherein the debris shredding equipment comprises:
(i) a rotating toothed drum having a plurality of removable shredding teeth mounted on the toothed drum in a V-formation with the apex of the formation in a trailing position;
(ii) a removable screen for screening the shredded debris, the screen having sieve gaps of a selected size through which the shredded debris can pass to the shredded debris conveyor, wherein if the shredded debris is larger than a selected particle size, then the shredded debris will remain on the screen for further shredding, and if the shredded debris is smaller than the selected particle size, then the shredded debris will pass through the sieve gaps to the shredded debris conveyor, the selected particle size corresponding to the selected size of the sieve gaps; and
(iii) a feed plate and a ram for feeding the construction debris to be shredded to the debris shredding equipment, wherein the construction debris to be shredded at least partly falls onto the feed plate and the ram forces the construction debris to be shredded to the debris shredding equipment;
(d) a hopper for receiving and storing the shredded debris, wherein the hopper comprises a removal device, located proximal to the bottom of the hopper, for removing the shredded debris from the hopper;
(e) a shredded debris conveyor for conveying the shredded debris from the debris shredder enclosure to the hopper;
(f) a spreading device operatively connected to the hopper for receiving the shredded debris from the hopper and for depositing the shredded debris onto a location for depositing the shredded debris; and
(g) a self-propelled truck on which the mobile construction debris shredder is mounted.

39. The mobile construction debris shredder as claimed in claim 38, wherein:
the feed conveyor has a length sufficient to extend from the debris shredder enclosure to a pile of the debris to be shredded that is located distal from the mobile construction debris shredder and over any environmental controls located between the pile of the debris to be shredded and the mobile construction debris shredder; and
the spreading device has a length sufficient to extend from the hopper to a location for depositing the shredded debris distal from the mobile construction debris shredder and over any environmental controls located between the location for depositing the shredded debris and the mobile construction debris shredder.

40. The mobile construction debris shredder as claimed in claim 39, wherein the hopper comprises a live bottom having at least one auger for more evenly distributing the shredded debris within the hopper.

41. The mobile construction debris shredder as claimed in claim 40, further comprising a magnetic device for removing ferrous metal from the shredded debris prior to the shredded debris being deposited in the hopper.

42. The mobile construction debris shredder as claimed in claim 41, wherein the debris shredder enclosure further comprises a safety door between the feed conveyor and the debris shredding equipment.

43. The mobile construction debris shredder as claimed in claim 42, wherein the hopper comprises a precursor device, located proximal to the top of the hopper, for more evenly distributing the shredded debris within the hopper.
